(19) United States
(12) Patent Application Publication
(10) Pub. No.: US 2012/0278634 A1
(43) Pub. Date: Nov. 1, 2012

(54) METHOD AND APPARATUS FOR SECURE ACCESS TO EXECUTION CONTEXT

(75) Inventors: Vesa-Veikko Luukkala, Espoo (FI); Sampo Juhani Sovio, Riihimaki (FI); Sergey Boldyrev, Soderkulla (FI)

(73) Assignee: Nokia Corporation, Espoo (FI)

(21) Appl. No.: 13/156,832

(22) Filed: Jun. 9, 2011

Related U.S. Application Data
(60) Provisional application No. 61/480,131, filed on Apr. 28, 2011.

(51) Int. Cl. G06F 21/00

(52) U.S. Cl. 713/189

(57) ABSTRACT

An approach is provided for providing secure access to execution context. An execution security platform determines an execution context of a device, the execution context including at least in part one or more computation closures. The execution security platform also processes and/or facilitates a processing of the execution context, the one or more computation closures, or a combination thereof to cause, at least in part, decomposition of the execution context, the one or more computation closures, or a combination thereof into, at least in part, one or more context criteria and content information, The execution security platform further determines to encrypt the execution context, the one or more computation closures, the content information, or a combination thereof using the one or more context criteria as a public key of an identity-based encryption.

### RELATED APPLICATIONS

This application claims the benefit of the earlier filing date under 35 U.S.C. §119(e) of U.S. Provisional Application Ser. No. 61/480,131 filed Apr. 28, 2011, entitled “Method and Apparatus for Secure Access to Execution Context,” the entirety of which is incorporated herein by reference.

### BACKGROUND

Mobile devices with various methods of connectivity are now for many people becoming the primary gateway to the internet and also a major storage point for personal information. This is in addition to the normal range of personal computers and furthermore sensor devices plus internet based providers. Combining these devices together and lately the applications and the information stored by those applications is a major challenge of interoperability. This can be achieved through numerous, individual and personal information spaces in which persons, groups of persons, etc. can place, share, interact and manipulate (or program devices to automatically perform the planning, interaction and manipulation of) webs of information with their own locally agreed semantics without necessarily conforming to an unobtainable, global whole.

Furthermore, in addition to information, the information spaces may be combined with webs of shared and interactive computations or computation spaces so that the devices having connectivity to the computation spaces can have the information in the information space manipulated within the computation space environment and the results delivered to the device, rather than the whole process being performed locally in the device. It is noted that such computation spaces may consist of connectivity between devices, from devices to network infrastructure, to distributed information spaces so that computations can be executed where enough computational elements are available. These combined information spaces and computation spaces often referred to as computation clouds, are extensions of the ‘Giant Global Graph’ in which one can apply semantics and reasoning at a local level.

In one example, clouds are working spaces respectively embedded with distributed information and computation infrastructures spanned around computers, information appliances, processing devices and sensors that allow people to work efficiently through access to information and computations from computers or other devices. An information space or a computation space can be rendered by the computation devices physically presented as heterogeneous networks (wired and wireless). However, despite the fact that information and computation presented by the respective spaces can be distributed with different granularity, still there are challenges in certain example implementations to achieve scalable high context processing within such heterogeneous environments. For example, in various implementations, due to distributed nature of the cloud, execution contexts (including data, information, and computation elements) are being exchanged among distributed devices within heterogeneous network environments wherein execution context with various levels of granularity and various structures is provided by and transmitted among various independent sources. In such environments, the security of execution contexts that are exchanged among distributed computational entities is a very important issue. In other words, it is important to have control over the migration of execution context, for example, by granting access to memory and other context to a computational entity only if the computational entity meets certain criteria.

### Some Example Embodiments

Therefore, there is a need for an approach for providing secure access to execution context.

According to one embodiment, a method comprises determining an execution context of a device, the execution context including at least in part one or more computation closures. The method also comprises processing and/or facilitating a processing of the execution context, the one or more computation closures, or a combination thereof to cause, at least in part, decomposition of the execution context, the one or more computation closures, or a combination thereof into, at least in part, one or more context criteria and content information. The method further comprises determining to encrypt the execution context, the one or more computation closures, the content information, or a combination thereof using the one or more context criteria as a public key of an identity-based encryption.

According to another embodiment, an apparatus comprises at least one processor, and at least one memory including computer program code, the at least one memory and the computer program code configured to, with the at least one processor, cause, at least in part, the apparatus to determine an execution context of a device, the execution context including at least in part one or more computation closures. The apparatus is also caused to process and/or facilitating a process of the execution context, the one or more computation closures, or a combination thereof to cause, at least in part, decomposition of the execution context, the one or more computation closures, or a combination thereof into, at least in part, one or more context criteria and content information. The apparatus is further caused to determine to encrypt the execution context, the one or more computation closures, the content information, or a combination thereof using the one or more context criteria as a public key of an identity-based encryption.

According to another embodiment, a computer-readable storage medium carries one or more sequences of one or more instructions which, when executed by one or more processors, cause, at least in part, an apparatus to determine an execution context of a device, the execution context including at least in part one or more computation closures. The apparatus is also caused to process and/or facilitating a process of the execution context, the one or more computation closures, or a combination thereof to cause, at least in part, decomposition of the execution context, the one or more computation closures, or a combination thereof into, at least in part, one or more context criteria and content information. The apparatus is further caused to determine to encrypt the execution context, the one or more computation closures, the content information, or a combination thereof using the one or more context criteria as a public key of an identity-based encryption.

According to another embodiment, an apparatus comprises means for determining an execution context of a device, the execution context including at least in part one or more computation closures. The apparatus also comprises means for processing and/or facilitating a processing of the execution context, the one or more computation closures, or a combination thereof to cause, at least in part, decomposition of the execution context, the one or more computation closures, or a combination thereof into, at least in part, one or more context criteria and content information. The apparatus further comprises means for determining to encrypt the execution context, the one or more computation closures, the content information, or a combination thereof using the one or more context criteria as a public key of an identity-based encryption.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing secure access to execution context, according to one embodiment;

FIG. 2 is a diagram of the components of execution security platform, according to one embodiment;

FIG. 3 is a flowchart of a process for providing secure access to execution context, according to one embodiment;

FIG. 4 is a diagram of the components of context criteria, according to one embodiment;

FIG. 5 is a diagram of opportunistic context search, according to one embodiment;

FIG. 6 is a utilization diagram of the process for applying execution context criteria for secure execution context sharing, according to one embodiment;

FIG. 7 is a diagram of retrieving context criteria, according to one embodiment;

FIG. 8 is an operational diagram for context encryption using execution context criteria, according to one embodiment;

FIG. 9 is a diagram of context criteria matching, according to one embodiment;

FIG. 10 is a diagram of a cloud structure for applying execution context criteria for secure execution context sharing, according to one embodiment;

FIGS. 11A-11C are diagrams of a cloud environment, according to one embodiment;

FIG. 12 is a diagram of hardware that can be used to implement an embodiment of the invention;

FIG. 13 is a diagram of a chip set that can be used to implement an embodiment of the invention; and

FIG. 14 is a diagram of a mobile terminal (e.g., handset) that can be used to implement an embodiment of the invention.

### DESCRIPTION OF SOME EMBODIMENTS

Examples of a method, apparatus, and computer program for providing secure access to execution context are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “computation closure” identifies a particular computation procedure together with relations and communications among various processes including passing arguments, sharing process results, flow of data and process results, etc. The computation closures (e.g., a granular reflective set of instructions, data, and/or related execution context or state) provide the capability of slicing of computations for processes associated with services, applications, device setup information (e.g., provided by a manufacturer), etc. and transmitting the computation slices between devices, infrastructures, clouds, information sources, etc.

As used herein, the term “cloud” refers to an aggregated set of information and computation closures from different sources. This multi-sourcing is very flexible since it accounts and relies on the observation that the same piece of information or computation can come from different sources. In one embodiment, information and computations within the cloud are represented using Semantic Web standards such as Resource Description Framework (RDF), RDF Schema (RDFS), OWL (Web Ontology Language), FOAF (Friend of a Friend ontology), rule sets in RuleML (Rule Markup Language), etc. Furthermore, as used herein, RDF refers to a family of World Wide Web Consortium (W3C) specifications originally designed as a metadata data model. It has come to be used as a general method for conceptual description or modeling of information and computations that is implemented in web resources; using a variety of syntax formats. Although various embodiments are described with respect to clouds, it is contemplated that the approach described herein may be used with other structures and conceptual description methods used to create distributed models of information and computations.

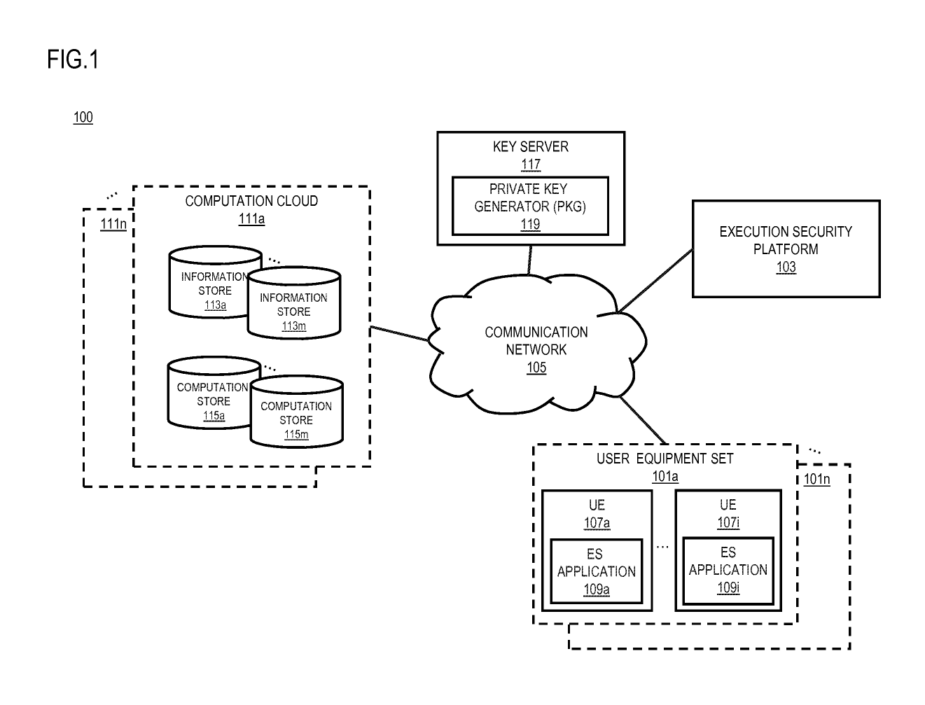

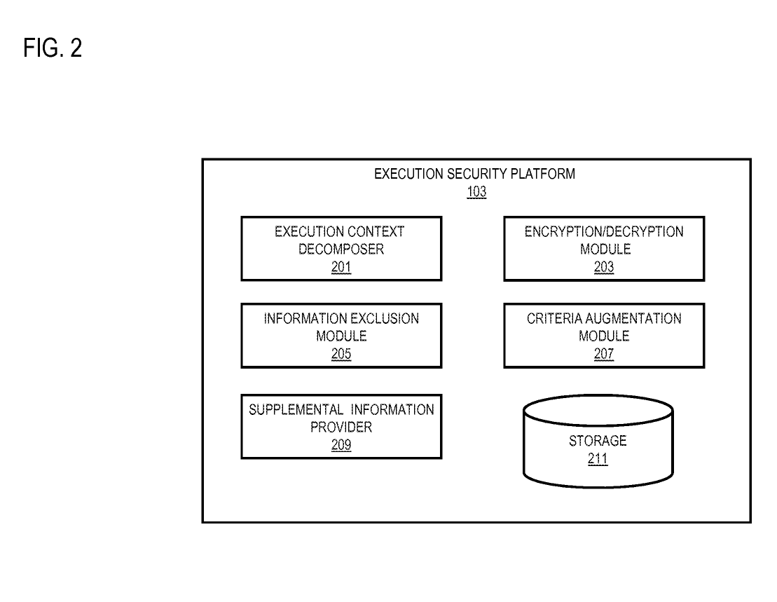

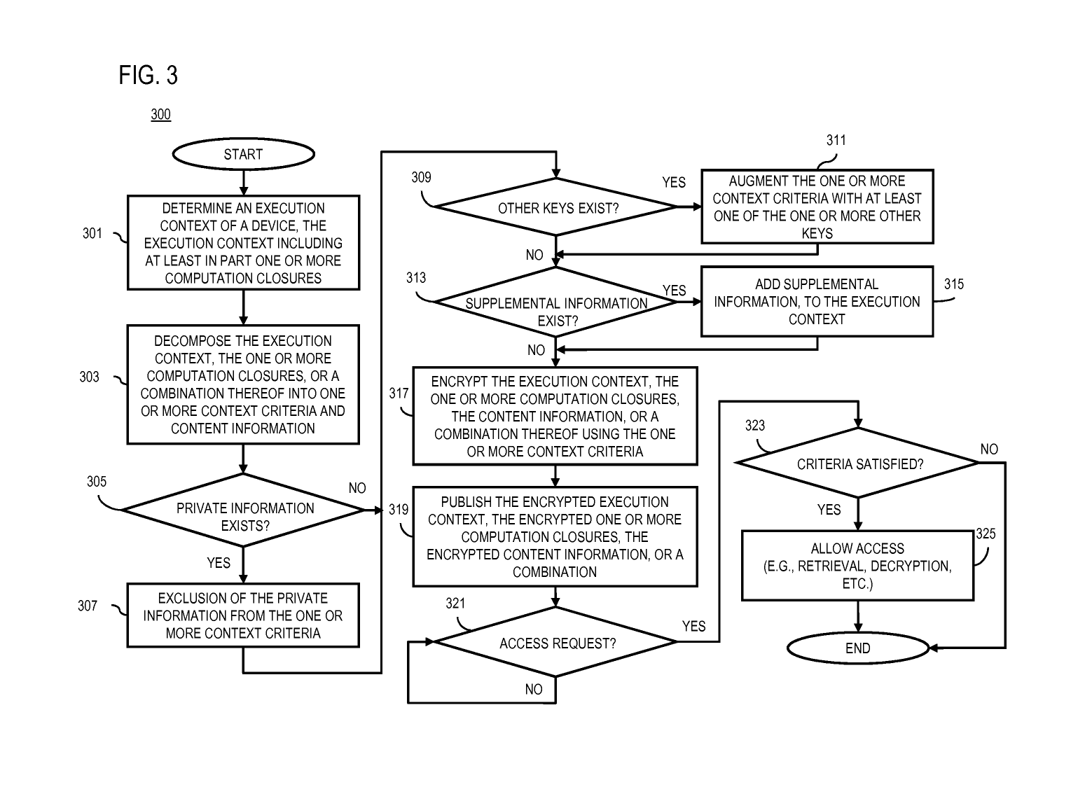

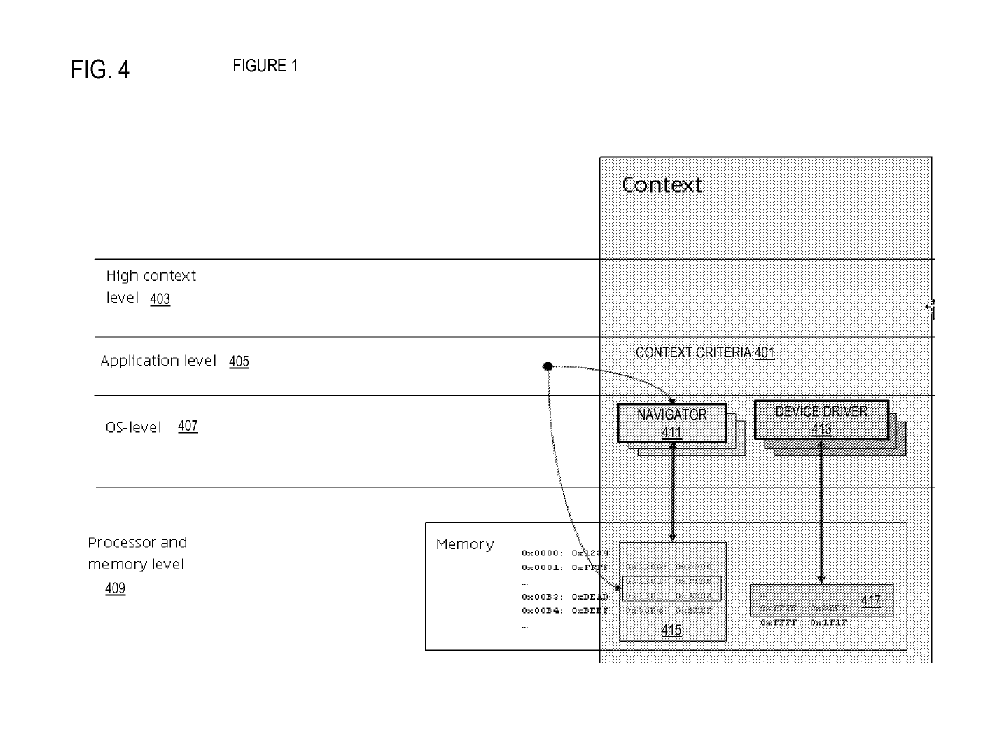

FIG. 1 is a diagram of a system capable of providing secure access to execution context, according to one embodiment. As previously described, a cloud environment consists of information and computations resources each consisting of many distributed devices that communicate information and computation closures (e.g., RDF graphs) via a shared memory. A device within a cloud environment may store computation closures locally in its own memory space or publish computation closures on a globally accessible environment within the cloud. In the first case, the device is responsible for any process needed for combination or extraction of computations, while in the second case the processes can be conducted by the globally accessible environment. Additionally, a device may have local wireless computational process performed within the device and other neighboring devices connected to wirelessly. In this case the process is conducted by an ad-hoc environment formed between the devices.

The basic concept of cloud computing technology provides access to distributed computations for various devices within the scope of the cloud, in such a way that the distributed nature of the computations is hidden from users and it appears to a user as if all the computations are performed on the same device. The cloud computing also enables a user to have control over computation distribution by transferring computations between devices that the user has access to. However, a user does not have control over the distribution of computations and processes related to or acting on the data and information within the cloud. In other words, a cloud in general does not provide a user (e.g., an owner of a collection of information distributed over the information space) with the ability to control distribution of related computations and processes of, for instance, applications acting on the information.

However, as part of the context sharing process, it is important to have control on context migration as the execution context can be communicated across potential insecure channels within one or more clouds. Also, the consistency of the execution context, as communicated across potentially insecure channels, is important. Moreover, parts of the execution context may not be safe to be published without at least some form of encryption. Public key cryptography is a widely used encryption/decryption method to protect data. However, use of long and randomly generated encryption keys and management and storage of encryption/decryption keys, encryption/decryption criteria, certificate, etc., are becoming daunting as the number of users, computing platforms, etc., and complexity of cloud structure in general is increasing. Further, the particular problem in publishing the execution context is how to publish the context with one or more criteria so that only intended recipients meeting execution context criteria can decrypt or otherwise access the shared execution context among the computational environments of one or more clouds.

To address this problem, a system 100 of FIG. 1 introduces the capability to provide secure access to execution context. In one embodiment, the execution security platform 103 queries one or more clouds 111a-111n with different criteria to obtain encrypted execution context which can be decrypted using those criteria.

In one embodiment, context execution is based on instantiating the context in different computational entities, as the context is communicated across potentially insecure channels. A computational entity can be any computational device, such as computers, user equipments, processing environments, etc. within the cloud environment, capable of executing computation closures associated with various processes. The context migration can be controlled by providing access to the context to a computational entity only if the computational entity meets certain criteria. These criteria can be deduced from system security policy, which defines context migration rules.

In one embodiment, elements of the execution context can be extracted and used as encryption keys for the context. For example, context elements associated with the identity of computational entities may be used for Identity-Based Encryption (IBE) schemes. In identity-based encryption, the public key of an entity, which provides unique information about the identity of the entity, can be used for encrypting the context.

In one embodiment, based on the IBE scheme, the parties involved in the communication (e.g., context migration) trust a third party called a Private Key Generator (PKG) to generate private keys for the communication. The encryption keys can be any arbitrary strings, however, only the PKG owns a master key that can be used for deriving decryption keys from encryption keys and common parameters. These common parameters are public and shared by all communicating entities. For example, if entity A wants to communicate an encrypted context to entity B, A may encrypt the context by using identity of B and other common parameters. Additionally, since entity A trusts PKG and knows that only PKG can derive decryption keys, entity A can be sure that only PKG and entity B are capable of decrypting the context, because PKG will provide the decryption keys only to entity B and not to any other entities. In this embodiment, the trusted PKG needs to maintain a large database containing decryption keys and criteria pairs between pairs of entities A and B.

In one embodiment, encrypting the context using certain portions of the context guaranties that execution may continue only in the computational entities that are intended to perform the execution. The use of IBE enables enforcement of policies associate with the execution and security. It is possible to define various rules and conditions on how context migration can be performed, wherein the rules may be provided by different stakeholders (e.g., information owners, servers, service providers, manufacturers, clouds, etc.)

In one embodiment, a computational entity A that is executing a context may encrypt the context based on an IBE scheme and publish the encrypted context with the aim that some other computational entity B can continue execution of the context. A computational entity B may query the published contexts to obtain a context to execute. Although, this process can be done by an individual computational entity B, but this is especially applicable to multiple active computational entities in the cloud, wherein all computational entities may follow similar or different policies. It is noted that from the point of view of the computational entity B, the cloud contains the encrypted contexts.

Additionally, the cloud may establish one or more policies regarding the distribution and migration of the contexts which have been published to the cloud. The policies may rely on the cloud being able to trigger behaviour based on the encrypted context as well as some additional criteria. The criteria can be linked to policy mechanisms, which may require additional transactions by the sender or recipient of the context (including financial transactions, joining a service for receiving advertisements, etc.). A policy may also modify the (encrypted) context to be compliant with a given policy.

For example, computational entity A may publish a context in order to have the cloud continue or share the burden of the context execution with other entities. The cloud may impose one or more policies on the published context. Furthermore, the setup of the computational entity A may explicitly require the context to be widely shared via the cloud (for example, as a vector of advertisements, creating a context with a game character, but also embedding advertisement to the game character), which may require a different kind of policy. Additionally, the cloud may impose conditions on participating computational entities, regardless of whether the entities publish or use the contexts.

In one embodiment, the contexts may consist of computational closures. As previously described, computational closures refer to relations and communications among various computations including passing arguments, sharing process results, flow of data and process results, etc. Once a computation is divided into its primitive computation closures, the processes within or represented by each closure may be executed in a distributed fashion and the processing results can be collected and aggregated into the result of the execution of the initial overall computation.

In one embodiment, the computational closures may have been previously constructed. In this case, the policies can be dynamically injected into the closures by the cloud. Assuming that computational entities A and B (and other similar entities) can access same shared public memory, each entity can encrypt confidential information prior to publishing them into the public memory.

In one embodiment, a computational entity A may independently divide the execution context into context criteria and content information. Context criteria (e.g., encryption criteria) can be used by the IBE as an encryption key for encrypting the content information. The context criteria can be a combination of state information or other information from various sources, including low level processor specific information, Operating System specific information, application specific information, higher level information, etc.

In one embodiment, the computational entities, which are the recipients of the execution contexts, are able to select the appropriate context to be executed. Various criteria can be identified, in order to enable the computational entities to efficiently query the execution context. For example, the context may be encrypted and labelled with one or more criteria. A derivative of the criteria can be used as a label. In other embodiments, different kinds of Binary Decision Diagrams (BDD) such as, for example, reduced ordered binary decision diagrams or augmented binary decision diagrams (AugBDD) can be used as the criteria.

As used herein, the term “decision diagram” refers to a compact graphical and/or mathematical representation of a decision situation, sets, or relations. A decision diagram, for example, may be a binary decision diagram (BDD) or a reduced ordered binary decision diagram (ROBDD). A BDD is “ordered” if different variables appear in the same order on all paths from the root. A BDD is “reduced” if any isomorphic subgraphs of its graph are merged and any nodes whose two child nodes are isomorphic are eliminated. Isomorphic subgraphs of the same decision diagram have similar appearance but originate from different sources. A ROBDD is a group of Boolean variables in a specific order and a directed acyclic graph over the variables. A directed acyclic graph (DAG) contains no cycles. This means that if there is a route from node A to node B then there is no way back. The term “AugBDD” refers to an augmented ROBDD which is augmented information including the ROBDD and at least one of a header with a construction history of the ROBDD, relationships between data tables, types and cardinality information, which places constraints on the types and number of class instances a property may connect. In one embodiment, the execution security platform 103 produces hash IDs from AugBDDs, and in other embodiments, in order to achieve efficiency, plain and un-keyed hash IDs may be produced.

As shown in FIG. 1, the system 100 comprises sets 101a-101n of user equipments (UEs) 107a-107i having connectivity to the execution security platform 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 107a-107i are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the UEs 107a-107i publish a representation of their local information and computations to the information stores 113a-113m and the computation stores 115a-115m, respectively. The execution security platform 103 can match all of the context criteria against the local information and computations, and find matches.

In one embodiment, the execution security platform 103 obtains an encrypted context from the cloud 111a-111n and deduces, based on the criteria (e.g., label) whether suitable criteria are locally available to potentially decrypt the context.

In one embodiment, the cloud 111a-111n has control over the context migration and can decide that certain conditions that may have been described in policy must be met before cloud 111a-111n allows the context to be distributed. One example of this kind of condition is that the user accepts cloud to perform certain actions.

In one embodiment, part of the encrypted context may be labelled for the cloud 111a-111n to automatically decrypt so that the decrypted information can trigger activities based on the context and policy enforcement. Additionally, the cloud 111a-111n may initiate automatic decryption and policy enforcement in various ways. For example, the cloud 111a-111n may initiate automatic decryption and policy enforcement when providing the decryption key to a computational entity based on a request (e.g., on demand mechanism). The cloud 111a-111n may also initiate automatic decryption and policy enforcement for all encrypted context. In this case the cloud may have PKG capabilities which allow the cloud to generate the necessary decryption keys. Furthermore, the cloud 111a-111n may initiate automatic decryption and policy enforcement when the encrypted context is purposefully targeted to the cloud, when the cloud has capability to fulfil the criteria set by the context owner (e.g., cloud acts as a computational entity).

In one embodiment, relevant encrypted contexts may include information associated with applications such as, for example, computation closures, hardware security features, device driver information, firmware information, program codes, etc. Furthermore, relevant policies may include, for example, allowing context migration only between particular software or hardware versions, allowing context migration only if a transaction between the publisher, reader and/or other relevant stakeholders has successfully concluded, etc.

In one embodiment a transaction may include a monetary transaction, joining a particular service, usage of a particular service (cloud may propose a variation of user's existing service), agreeing to loyalty program membership for a particular business (may include viewing advertisements), agreeing to publish more information to the cloud (including location), agreeing to let the cloud use one or more participant equipments as computational resources, a mutual consent between the publisher and the reader, etc. In another embodiment, the relevant policies may include, allowing migration only if suitable cloud resources are available.

In one embodiment, the policy may dictate that the completion of a transaction triggers another function (e.g., an advertising service), wherein certain kind of context induces injection of advertisements or other new context. For example, the new context may be a URI of an advertisement, an Operating System level process, etc.

In one embodiment, the re-encryption may be performed offline, meaning that the re-encryption may not necessarily be triggered by a requirement of the decryption key from the PKG.

In one embodiment, the injected content may be a context specific content based on the encrypted context. For example, the injected content may be related to a new version of the device driver. This counts on relevant information about the device driver being in the context.

In one embodiment, the encrypted context may contain a delimited set of computational closures. It is noted that the sensitive and private data of the entity requesting encryption is not explicitly included in the criteria, but is implicitly used. The implicit adding of the sensitive data in the criteria can be triggered by the context that is being encrypted. For example, while encrypting media content, the criteria can be automatically augmented with the device or user specific Digital Rights management (DRM) key. Additionally, or alternatively, the user can select a set of privacy sensitive data which is pertinent to certain content. For example, the user may select that whenever media content is to be encrypted, the DRM key will be included in the sensitive data, or whenever health related information is published, the social security number is implicitly added to the criteria. It is noted that the sensitive data will never be published as unencrypted context for the cloud 111a-111n.

In one embodiment, a private Key generator (PKG) 119 of a key server 117 may use various methods to verify identity of the entity requesting a private key. For example, the PKG 119 may verify the identity based on the access rights of the entity or the component containing the entity. Alternatively, the PKG 119 may access information from the information store 113a-113m and make deductions from the information. For example, if a UE 107a-107i offers criteria stating that the user is a fan of the Beatles, the PKG 119 may check whether the user of UE 107a-107i belongs to any Beatles fan clubs. Additionally, the PKG 119 may make history based deductions. For example, the PKG may check whether the user of UE 107a-107i has listened to any Beatles songs. The PKG 119 may be associated with a PKG infrastructure (not shown) that provides access rights, policies, rules, configurations, etc. to the PKG 119.

In one embodiment, the execution security platform 103 distributes the common IBE parameters among the execution environments or stores them in a common information store 113a-113m or storage 211 to be accessed by the UEs 107a-107i or any other component of the cloud environment. The execution security platform 103 may control access to the IBE parameters via various access control means.

In one embodiment, the PKG 119 may utilize remote attestation techniques such as late launch to guarantee that a UE 107a-107i does not masquerade its execution context. Late launch provides the ability to measure and invoke a program, typically a security kernel or Virtual Machine Monitor (VMM), in a protected environment. Upon receiving a late launch instruction, the computational entity switches from the currently executing operating system to a Dynamic Root of Trust for Measurement (DRTM) from which it is possible to later resume the suspended operating system. The integrity verification of the computational entity may involve verification of public key certificate to verify that the executed program code is signed by an authorized party.

In one embodiment, contents such as advertisements can be included in the encrypted context to act as a vector of advertisement on behalf of the encryption requesting entity. The entity may publish desirable content with suitable context and then include advertisements to the context to be encrypted. For instance a context may include a powerful game character, which can then only be used so that the advertisements are shown or so viewing of the advertisements will make the character more powerful. As another example, the content may be a coupon or gift voucher which has been encrypted using the context which the advertisement placer finds most pertinent. This provides better targeting for the advertisement placer. The advertisement content may be only referred by the sender. In this case, the actual content may be inserted by the cloud when service is initiated as explained above.

By way of example, the UEs 107a-107i, and the execution security platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

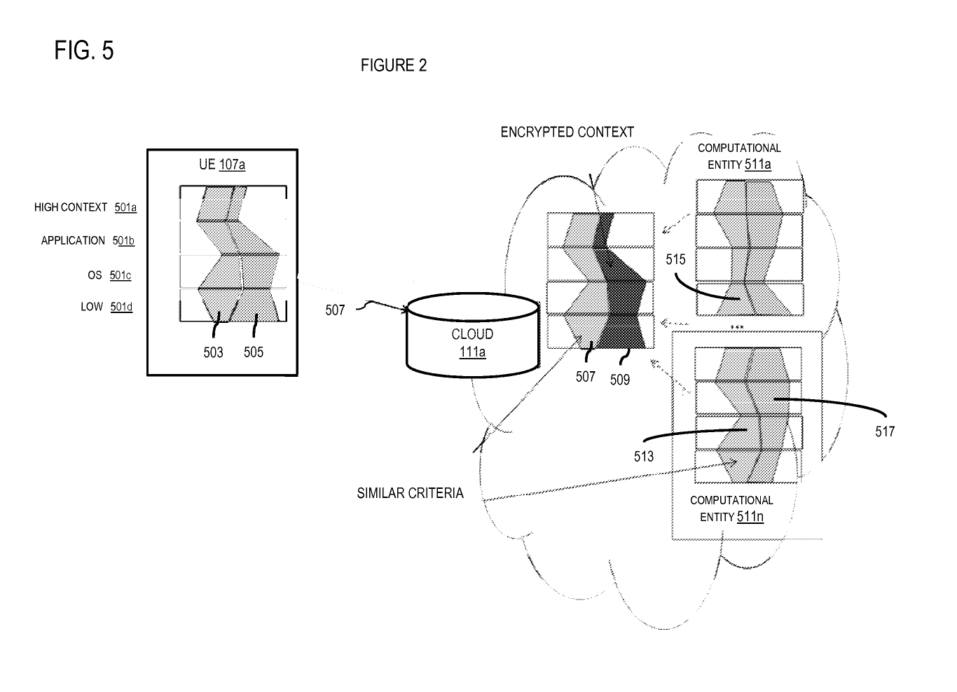

FIG. 2 is a diagram of the components of execution security platform, according to one embodiment. By way of example, the execution security platform 103 includes one or more components for providing secure access to execution context. It is contemplated that the functions of these components may be combined in one or more components or performed by other components of equivalent functionality. In this embodiment, the execution security platform 103 includes an execution context decomposer 201, an encryption/decryption module 203, an information exclusion module 205, criteria augmentation module 207, a supplemental information provider 209, and a storage 211.

FIG. 2 is described with reference to FIG. 3, wherein FIG. 3 shows a flowchart of a process for providing secure access to execution context, according to one embodiment. In one embodiment, as shown in step 301 of FIG. 3, the execution context decomposer 201 determines an execution context of a device, (e.g., a UE 107a-107i). The execution context may include one or more computation closures, wherein each computation closure represents a slice of computation associated with processes of services, applications, device setups, etc. Computation closures are stand alone processes that can be transmitted between devices, infrastructures, clouds, information sources, etc. to be executed. For example, the execution context decomposer 201 may retrieve the computation closures from the computation stores 115a-115m, the storage 211, or a combination thereof.

In one embodiment, the execution context decomposer 201 processes and/or facilitates a processing of the determined execution context, the one or more computation closures, or a combination thereof to cause decomposition of the execution context, the one or more computation closures, or a combination thereof into one or more context criteria and content information (per step 303 of FIG. 3). The execution context may include computation elements (e.g., code), data, execution parameters, execution requirements, etc. The execution decomposer 201 decomposes the context into context criteria and context. The context criteria may include policies that define the rules, conditions, and requirements that govern context migration and distributed execution of the context, while the content information may include the computation elements (e.g., computation closures) and the information that the computations are applied on (e.g., input data, parameters, etc.). The context criteria may also include information related to the identity of computational entities that execute the computations included in the context. As previously described, the identity information included in the context criteria can be used as Identity-Based Encryption (IBE) schemes to encrypt the context. In identity-based encryption, the public key of an entity, which provides unique information about the identity, can be used for context encryption.

It is noted that the context criteria may contain non-sensitive and sensitive information, wherein the sensitive information should be protected as private information. Since the private part of context criteria cannot be used as a public key for identity-based encryption, the private criteria should be excluded from the context criteria prior to the use of context criteria as public key. In one embodiment, per step 305 of FIG. 3, the information exclusion module 205 processes and/or facilitates a processing of the content information to determine private information. If private information is found, the information exclusion module 205 causes exclusion of the private information from the one or more context criteria, per step 307 of FIG. 3.

In one embodiment, the execution security platform 103 may augment the context criteria prior to using the criteria as identity-based key for execution context encryption. The augmentation enables the execution security platform 103 to use a derivative of the context criteria as encryption key. As previously described, various augmentation methods can be applied for creating the encryption key for the content information. For example, Binary Decision Diagrams (BDD), such as reduced ordered binary decision diagrams or augmented binary decision diagrams (AugBDD) can be used as the criteria. In one embodiment, the criteria augmentation module 207 determines one or more other keys for accessing at least a portion of the content information (shown in step 309 of FIG. 3). Subsequently, per step 311 of FIG. 3 the criteria augmentation module 207 augments the one or more context criteria with at least one of the one or more other keys. The one or more other keys may include, at least in part, one or more digital rights management (DRM) keys. DRM keys are keys used by access control technologies that are used by hardware manufacturers, publishers, copyright holders and individuals to limit the use of digital content and devices.

In one embodiment, per step 309 of FIG. 3, the criteria augmentation module 207 receives an input for specifying the one or more other keys, other private information, or a combination thereof associated with the content information, wherein the augmentation of the one or more context criteria comprises, at least in part, associating the one or more other keys, the other private information, or a combination thereof with the one or more context criteria. The input may be retrieved from the storage 211, provided by a user of UE 107a-107i, provided by the cloud 111a-111n, provided by an authority of communication network 105, or a combination thereof. The other key or the other private information may include, at least in part, one or more personal identifiers such as for example, social security numbers, account IDs, user names, telephone numbers, International Mobile Equipment Identities (IMEI), etc.

In one embodiment, the supplemental information provider 209 may process and/or facilitate a processing of the execution context to add supplemental information, wherein access to the execution context is contingent, at least in part, on accessing the supplemental information, (step 315 of FIG. 3). The supplemental information may include, for example, advertisement information, coupon information, gift voucher information, or a combination thereof. The supplemental information may be provided by a provider (not shown) and placed in storage 211, in cloud 111a-111n, or a combination thereof. The supplemental information provider 209 may check whether supplemental information exists (per step 313 of FIG. 3) and verify the policies associated with the execution context and the supplemental information prior to determining whether the supplemental information should be added to the execution context.

In one embodiment, the encryption/decryption module 203 determines to encrypt the execution context, the one or more computation closures, the content information, or a combination thereof using the one or more context criteria as a public key of an identity-based encryption (per step 317 of FIG. 3).

In one embodiment, the encryption/decryption module 203 causes, at least in part, publication of the encrypted execution context, the encrypted one or more computation closures, the encrypted content information, or a combination thereof to an information store 113a-113m, a network service, a network storage, or a combination thereof, as seen in step 319 of FIG. 3.

In one embodiment, per step 321 of FIG. 3, the encryption/decryption module 203 checks whether there is an access request for the published encrypted execution context, content information or a combination thereof. The access request may be provided by one or more UEs 107a-107i, computational entities or processing components within the environment of cloud 111a-111n, or a combination thereof. If an access request exists, per step 323 the encryption/decryption module 203 checks whether the requesting computational entity satisfies the execution criteria (e.g., provides the correct key, ID, etc.). If the provided criteria matches with the criteria used for the encryption of the context, per step 325 the encryption/decryption module 203 allows the retrieval of the encrypted execution context. The encryption/decryption module 203 may decrypt the encrypted one or more computation closures, the encrypted content information, or a combination thereof from the cloud 111a-111n, the network service, the network storage, or the combination thereof based, at least in part, on the satisfied criteria by the requesting computational entity. Otherwise, if the criteria are not satisfied, the access to the encrypted context is denied.

FIG. 4 is a diagram of the components of context criteria, according to one embodiment. In one embodiment, the execution security platform 103 may independently divide the execution context into context criteria and content information. Context criteria (e.g., encryption criteria) can be used by the encryption/decryption module 203 as an encryption key (e.g., using an IBE scheme) for encrypting the context. The criteria can be a combination of state information or a combination of information from many sources. For example, the context criteria can be a combination of information from different levels of the architecture. As seen in FIG. 4 the context criteria 401, can be a combination of information from high context level 403, application level 405, OS level 407 and processor and memory level 409. The high context level 403 may include information such as user preferences, user presence information, information provided by social networks, etc. The application level 405 may include application specific information such as, for example, distance to a point or time to a point for a mapping/navigation application. The OS level information 407 may include any information related to virtual memories, process memory spaces, access to system resources, etc. And the processor and memory level information 409 may include binary data or machine code stored in the memory.

In the example of FIG. 4, the context criteria associated with the application navigator 411 is selected from the application level 405, the OS level 407 and the processor and memory level 409. In this example, the Navigator 411 may represent the content information while the code 415 represents the context criteria associated with this content. Similarly, the content information of device driver 413 may be associated with the context criteria 417 from the processor and memory level 409.

It is noted that the context criteria (e.g., encryption key) and the content information can be chosen independently. This allows the execution security platform 103 to select the context in a way to form a consistent whole from a specific point of view. Therefore, the context migration can be done at different levels of information granularity and semantic level.

FIG. 5 is a diagram of opportunistic context search, according to one embodiment. In one embodiment, the UE 107a contains execution context consisting of the context criteria 503 and the context 505. The execution context may include context criteria that consist of state information retrieved from the context of one or more layers of the architecture. The state information may include state information associated to high context level 501a, application level 501b, operating system 501c, and low level (e.g., processor and/or memory level) 501d. In one embodiment, the execution security platform 103 encrypts the context using the context criteria 503 (e.g., IBE) and publishes the IBE-encrypted context to cloud 111a via arrow 507. Publication of the execution context provides context sharing with other components within the environment of the cloud 111a, including other UEs 107a-107i, computational entities, etc.

In one embodiment, the context criteria 507 and the encrypted context 509 are the published equivalent of the criteria 503 and the context 505, wherein the context 509 is encrypted using the criteria 507. On the other hand, cloud 111a may have connectivity to multiple computational entities 511a-511n wherein each computational entity may have the capability of executing the encrypted context 509. However, as seen in the example of FIG. 5, the computational entity 511n has criteria 513 which is similar to the criteria 507 while the criteria 515 of computational entity 511a is not similar to criteria 507.

In one embodiment, the context 505 encrypted using the context criteria 503 is published in the cloud 111a as context 509. A participant of cloud 111a, such as computational entity 511n, that can present the satisfactory criteria 513 can access the encrypted context 509, gain access to the decryption key, and decrypt the encrypted context 509. Accordingly, the computational entity 511n determines a set of context criteria 513 and presents the criteria 513 to the execution security platform 103. In one example, encryption/decryption module 203 can verify the criteria 513 and compare them to the criteria 507 (or 503). If the criteria are met, the encryption/decryption module 203 may decrypt the context or initiate transmission of a decryption key to the entity 511n. The entity 511n can use the received decryption key, the common parameters, the encrypted context, or a combination thereof to decrypt the encrypted secret data to get the context. The criteria 513 and the derived context 517 are combined to derive the execution context to be executed on the entity 511n.

It is noted that there may be several potential other computational entities 511a-511n which are able to execute the context 509. In one embodiment, the computational entities 511a-511n may search or query the cloud 111a for suitable potential contexts that they can execute. Upon finding a suitable context, the computational entity may decrypt and execute the context under the supervision of the encryption/decryption module 203.

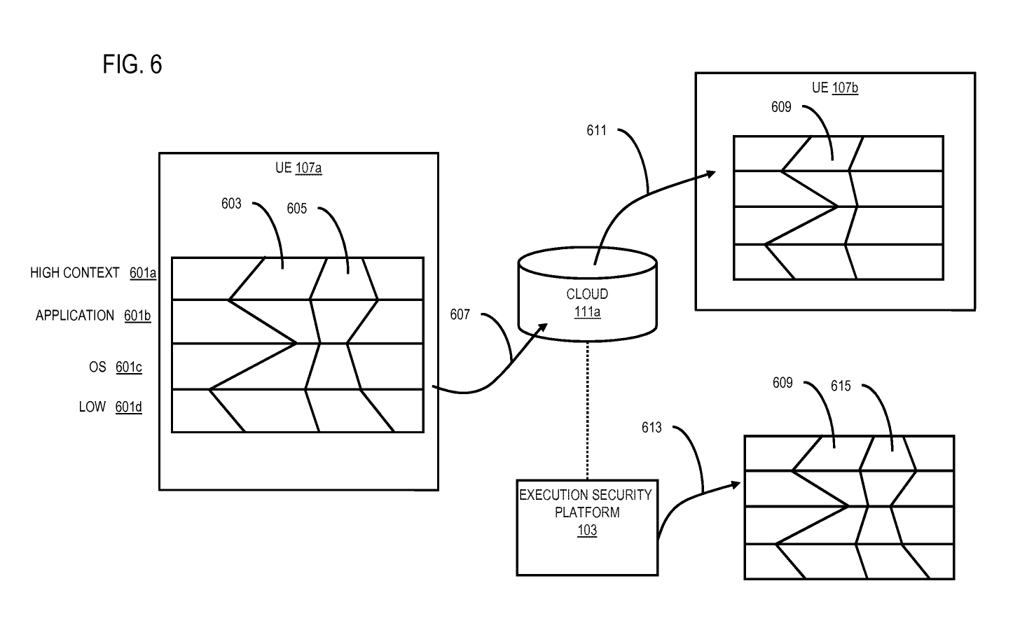

FIG. 6 is a utilization diagram of the process for applying execution context criteria for secure execution context sharing, according to one embodiment. Considering a situation shown in FIG. 6, a UE 107a is sharing an execution context with another participant UE 107b in, for example, the system 100 of FIG. 1, using one or more context criteria. In one example, the users of UE 107a and 107b have started execution of an application (e.g., a game) on UE 107a. Further, the users or the cloud 111a-111n may determine for the execution to continue on UE 107b, for example, because UE 107b may have a faster processor or more memory space available for the application. According to this example, the execution context associated with the execution of the game is encrypted based on one or more context criteria determined by the execution security platform 103. The encrypted execution context can be published on the cloud 111a-111n so that it can be access by UE 107b, if desired context criteria is presented and verified. According to this example, the execution context can include the context criteria 603, including state information associated with the execution context retrieved from one or more layers of the execution context, and the context 605. In the example of FIG. 6, the execution context (which includes criteria 603 and context 605) can include state information associated to high context level 601a, application level 601b, operating system 601c, and lower level (e.g., processor and/or memory level) 601d.

By way of example, UE 107a can determine the one or more conditions used to determine the one or more context criteria 603 to be used for encryption of the context 605. An exemplary set of context criteria 605 is shown in Table 1:

TABLE 1

| | |
|---|---|
| :c | |
| :game “Chess” | # Application context |

| | |
|---|---|
| :player “Alice” | # high context |
| :player “Bob” | # high context |
| :exe_name “chess.exe” | # OS context |
| :architecture “ARM-9” | # Processor and memory context |
| :OS “maemo-linux 1.5” | # OS context |
| :number_of_moves “21” | # Application context |

The criteria application of the UE 107a (for example, ES application 109a) uses the determined context criteria (for example Table 1), the master public key, domain parameters, or a combination thereof to encrypt the context 605 and can publish the encrypted context, shown by arrow 607, to the cloud 111a, which in turn, relays the encrypted context to the UE 107b, per arrow 611. According to another embodiment, ES application 109a can construct an RDF graph containing the context criteria, can convert the RDF graph into a ROBDD, and can compute a AugBDD hash identifier for the ROBDD via C_ID=AugBDD(:c). The hash identifier can be used for encryption purposes. UE 107a can also determine the secret data, e.g., context 605 that needs encryption. In one example, the secret data is shown in Table 2:

TABLE 2

| | |
|---|---|
| :s | |
| :memory_start “0x01AG” | # Processor level ... |
| :memory_end “0xFFAA” | |
| :memory “0xACDC43210...” | # truncated |
| :chess_tileset “3d-pieces” | # application level |

According to certain embodiments, the secret data can be converted into a ROBDD and a hash identifier can be generated via S_ID=AugBDD(:s). A set of IBE common domain parameters (e.g., common_pars) can be obtained from, for example, the private key generator 119, storage 211, etc. The hash identifier of the secret data can be encrypted using, for example, the hash identifier of the context criteria and the common parameters as Msg=IBE_crypt(common_pars,C_ID,S_ID).

The context 605 encrypted using the context criteria 603 is published in the cloud 111a. A participant, such as UE 107b, that could present the satisfactory criteria can access the encrypted context, gain access to the decryption key, and decrypt the encrypted context. Accordingly, the participant UE 107b determines a set of context criteria 609 and presents the criteria 609 to the execution security platform 103. In one example, encryption/decryption module 203 can verify the criteria 609 and compare them to the criteria 603. If the criteria are met, the encryption/decryption module 203 may decrypt the context or initiate transmission of a decryption key to the UE 107b. The UE 107b can use the received decryption key, the common parameters, the encrypted context, or a combination thereof to decrypt the encrypted secret data to get the context. The criteria 609 and the derived context 615 are combined to derive the execution context to be executed on the UE 107b.

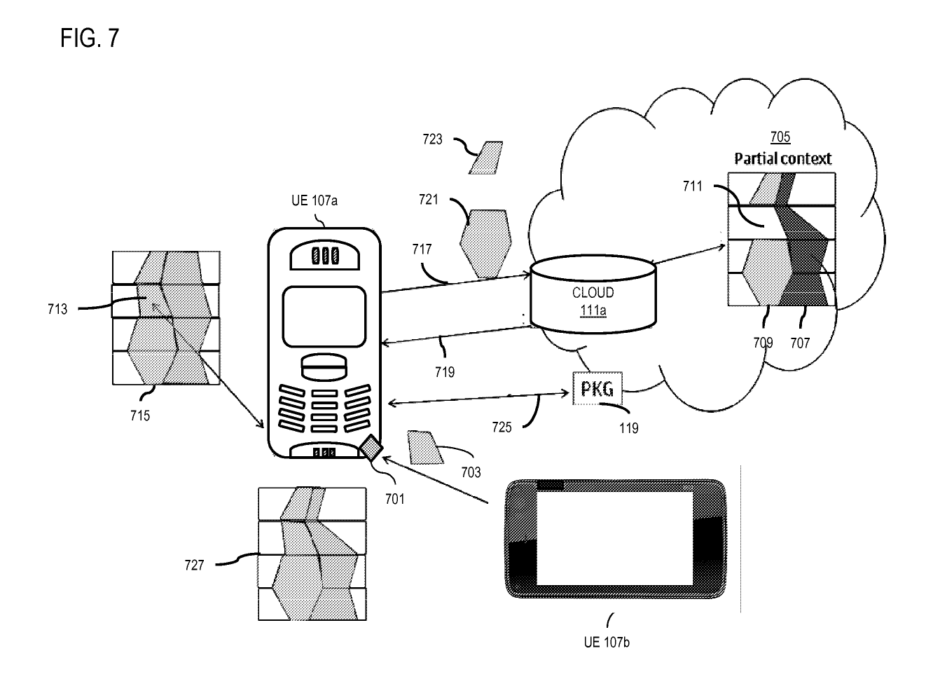

FIG. 7 is a diagram of retrieving context criteria via near field communication, according to one embodiment. In one embodiment, the process of querying the cloud 111a-111n can be triggered by means of an external stimulus (invoked via an out-of-band channel) which may include a. Radio Frequency ID (RFID) activation such as near field communication (NFC).

In one embodiment, the UE 107a receives the application portion 703 of the criteria from UE 107b via RFID 701. For example, the application portion 703 may be a chess game application. The cloud 111a may contain partial context 705 such that the content part 711 of partial context 705 is decrypted. However, the application level portion 711 of the criteria portion 709 of context 705 is missing. In this example, it is assumed that, for privacy reasons, UE 107b has been setup in a way that it cannot publish the full criteria to cloud 111a (which, for example, may reveal to others that the user is playing chess during working hours).

In one embodiment, the UE 107a verifies that the application portion 703 of the context matches with the application portion 713 of its own criteria 715. This indicates a possibility that there is a partial matching context in cloud 111a. subsequently, the UE 107a queries the cloud 111a regarding the context per arrow 717 and as a result the cloud 111a, per arrow 719 sends the IBE encrypted partial context 721 and 723 to UE 107a. Upon receiving the encrypted context, per arrow 725 the UE 107a retrieves the decryption key corresponding to the criteria 715 from the PKG and decrypts the partial context using the key and generates the complete context 727 with the application level context 703, low level and OS level 721, and the high context level 723.

In other embodiments, the query process to cloud 111a may be triggered by user context detection, wherein the context may include a set of detected radio bearers, a radius within a location, etc. The query process may also be triggered based on receiving additional search criteria via messaging, such as SMS, email, instant messaging, etc.

It is noted that the first step of sending the application portion 703 from UE 107b to UE 107a needs to be done only once, for example when the user of UE 107b creates an account on cloud 111a. In one embodiment, an optional header can be associated with the content. If no header is used, a computational entity that meets the criteria or has corresponding decryption key will not be able to determine whether it can decrypt the received context unless it tries to decrypt.

In one embodiment, the header may contain the criteria. If cloud 111a makes the header public (available to everyone), other computational entities may generate more encrypted context for the group of entities that meet the criteria. However only entities that meet the criteria may decrypt the context. Furthermore, since exposing the criteria increases the possibility of spam attacks, it may be desirable that the cloud 111a does not publish the criteria.

In another embodiment, the header may contain some derivative of the criteria, for example hash or keyed hash of the criteria. Using hashes prevents the above spamming problem and allows the cloud 111a to publish the headers. However, in this case the query process may become more complex, since the computational entity must compute the derivative from potential criteria and compare the derivates. If keyed hash is used, only the computational entities with proper key for keyed hash may encrypt the context.

In the example of FIG. 7, the user of UE 107b may set the criteria accordingly, potentially aided by heuristics which auto-select the relevant OS and program information. The user of UE 107b may submit the criteria to the PKG 119 and obtain the decryption key for getting the rest of the context. The full context is reassembled at UE 107b and the execution (e.g., game) may continue.

In one embodiment, the security service can be automatically initiated based on security or privacy parameter. The cloud 111a-111n, may operate automatically based on one of the following acts:

In one embodiment, the encryption/decryption module 203 of the execution security platform 103 may target the context directly to the cloud 111a. In this case, the criteria known to the cloud 111a, which the cloud can meet, is used as encryption key.

In another embodiment, the cloud 111a may be capable of decrypting the entire context. This can be the case when PKG 119, that provides all decryption keys, is inside the cloud 111a environment. However, in this situation the cloud 111a may be enforced to do huge amounts of decryptions, which may cause severe performance issues.

In yet another embodiment, the PKG 119 may be triggered immediately after deriving the decryption key for some computational entity. This may be the best option in most designs since, after key derivation the PKG 119 knows that some context for this decryption key exists in cloud 111a (at least in cases that encrypted context are labeled with headers). In this embodiment, there is a communication between the PKG 119 and the cloud 111a.

Subsequently, the cloud 111a may query all encrypted context with corresponding encryption keys. The cloud 111a may decrypt the context, analyze decrypted context and search instructions for the cloud in the context, and execute the instructions.

Upon the decryption of the context by cloud 111a, various service initiations can be performed using existing Application Programming Interfaces (APIs). Potential re-encryption of the context after modifying it with advertisements or similar information can be done using the IBE mechanism with a modification of the above embodiments. However, this relies on the criteria or its derivative availability in the header. In one embodiment, the PKG 119 initiates the procedure of decryption. However, in the case where the header contains the criteria, the cloud 111a may internally use this criteria to obtain the encryption key and use that to re-encrypt the context.

In one embodiment, the use of computation closures may allow the separation of business logic and the policies by construction. The cloud 111a may detect closures that have been built this way and inject new policies into the decrypted closure. These new policies may be custom generated for the current state of the cloud 111a and its participating devices providing optimal use of resources.

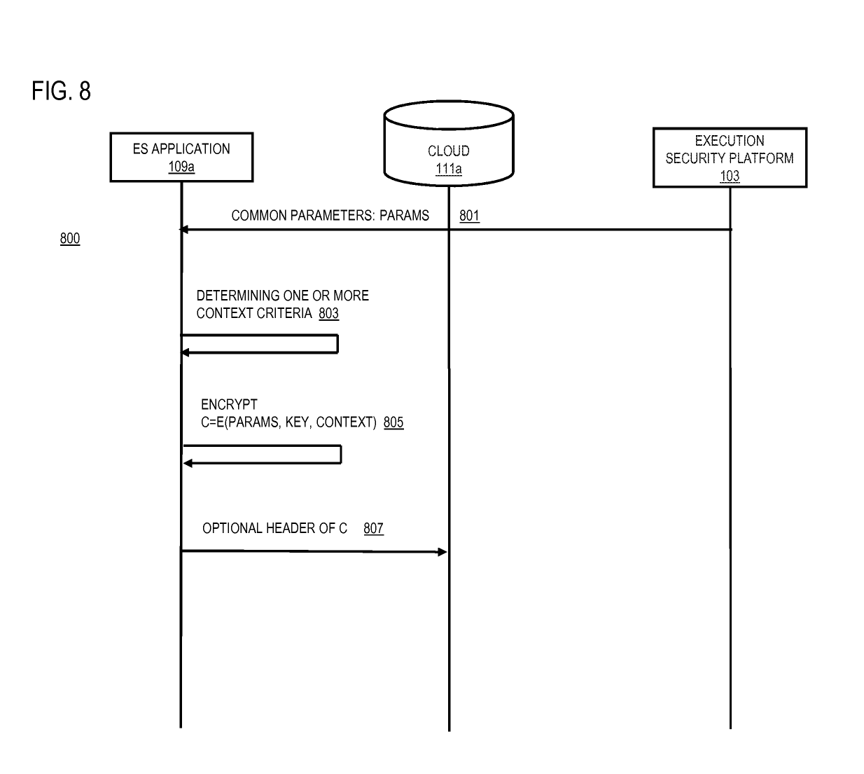

FIG. 8 is an operational diagram for context encryption using execution context criteria, according to one embodiment. In step 801, the execution security platform 103 can transmit IBE common parameters to the Execution Security (ES) application 109a of a UE 107a. In one example, this operation is typically performed once, for instance, when a user and/or UE register with a service of a service provider; a UE is manufactured; etc. The IBE common parameters can be used in accordance with determined context criteria for encryption of the execution context. Accordingly, at process 803, the ES application 109a determines one or more context criteria associated with the execution context to be encrypted. The determined one or more context criteria can be used, for example, as public key in the IBE scheme. The execution context (and/or a portion of, representation of, etc.) is further encrypted using the common parameters, the key, or a combination thereof by process 805. The encrypted execution context is optionally published to the cloud 111a at step 807.

The optional message 807 sent to the cloud 111a can include the context criteria and/or a header. For example, the message can be an email, SMS, EMS, MMS, etc.; and the header can describe or otherwise specify the context criteria. When the context criteria are sent in a message without a header, the cloud 111a or any intended recipient can read the context criteria transmitted through a logically separate message. The separate message makes the context criteria visible, by, for example, not encrypting the context criteria. On the other hand, if the context criteria are not described in the header or transmitted through the separate message, the intended recipient, that meets the specified criteria and/or has a corresponding decryption key given by the cloud 111a, cannot determine whether to decrypt the published encrypted secret context before trying to decrypt the encrypted secret context.

When the message is sent with a header containing the context criteria, the cloud 111a can take action based upon the header without reading the message body. Further, if the cloud 111a can make the header available for everyone, the intended recipient can determine whether to decrypt the encrypted secret context before trying to decrypt it. It is noted that under some conditions, although non-intended recipients (e.g., as other entities) may have no key to open up or decrypt the published encrypted secret context, the non-intended recipients may nonetheless use the context criteria described in the header to generate other encrypted secret context (e.g., spam, etc.) targeted at the group of intended recipients. When the ES application 109a is concerned about such spam attacks or other unwanted information resulting from the context criteria described in the header, the ES application 109a can still include the header in the message while requesting that cloud 111a not to publish the context criteria.

According to certain embodiments, the header can also include a hash and/or keyed hash of the context criteria. In this example, using hashes can prevent the above spamming problem and can allow cloud 111a to publish the headers. However, the query can be more complex, since the computational entity may need to compute the derivative from potential criteria and compare the derivatives. Additionally or alternatively, if key hash is used, then entities (such as UEs, applications, entities, etc.) with the proper key for the keyed hash may encrypt the context.

The above-described embodiments independently encrypt without collaboration, input, or creating any direct relationships to the intended recipients. Instead, the encryption is based on context criteria defining criteria associated with execution context without specifically identifying the recipients.

In an additional or alternative implementation, the above-described embodiments can be utilized as part of the cloud infrastructure. In one exemplary embodiment, the cloud infrastructure can be implemented, which can provide availability to all locations in the functional architecture. In one example, the infrastructure can offer a functional architecture that can provide, for example, cross domain search extent for information resulting in enormous opportunities in application development.

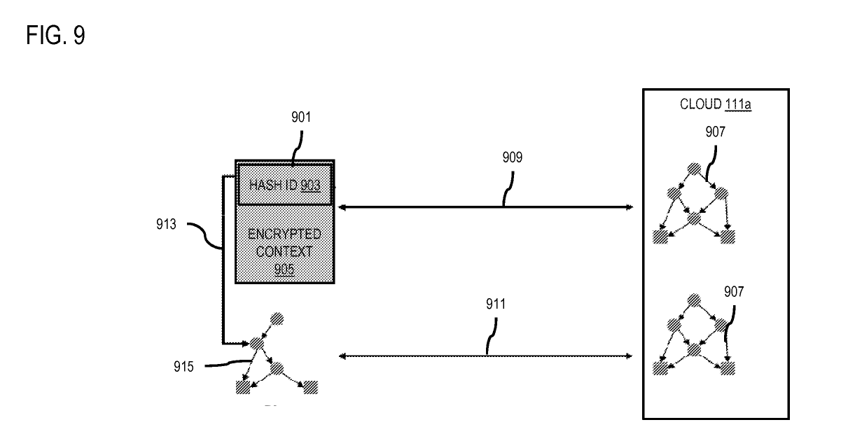

FIG. 9 is a diagram of context criteria matching, according to one embodiment. In one embodiment a participating computational entity 901 may have local information (in this example shown as graph representation) and the local information may contain criteria for encrypted information in the cloud 111a which could be used as criteria to unlock the information. This mechanism is logically separate from decrypting the information. In one embodiment, in first step, per arrow 909 the entity 901 obtains the encrypted information from graph 907. This information may include the criteria. The process of determining the validity of the criteria by entity 901 is as described in FIG. 8. It is assumed that the entity 901 has selected criteria and in next step it reconstructs the criteria graph 915, via arrow 913. This may be a dedicated service logically separated from the cloud 111a, or it may be contained within the cloud 111a, accessible by same primitives as the rest of the information. For criteria, the PKG 119 may perform checks on it and checks on the entity 901 offering the criteria prior to returning the key. At this point there may be communication between cloud 111a and the PKG 1119 (such as triggering activities on the cloud side or checking for additional information). If the criteria is accepted, the entity 901 obtains a key, which it may use to decrypt the context.

In various embodiments, different implementations for searching of the encrypted information in cloud 111a can be used. For example, the entity 901 may query the cloud and obtain a list of suitable candidates: [(msg_{—}1,C_ID_{—}1), (msg_{—}2,C_ID_{—}2), . . . ].

For the purpose of optimization, it is possible to query only for the criteria and not for the encrypted context and if necessary, the context can be queried later. These C_IDs are AugBDD hashes which are locally available to the querying entity 901. The AugBDD solution allows efficient calculation of BDD inclusion.

It is noted that the individual AugBDD hashes can be compared to local hashes by simple equality check, for example, comparison between graph 915 and graph 907 via arrow 911. Also, the inclusion of each potential criteria candidate can be checked with the whole graph of local information efficiently by AugBDD inclusion. If a C_ID exists on the entity side, it shows the possibility to decrypt the secret information, for example, C_ID_{—}1

In one example, per step 909 the entity 901 passes C_ID_{—}1 to cloud 111a and offers, if necessary the AugBDD graph 915 as a proof. In response, the entity 901 receives from the execution security platform 103 (via cloud 111a) a decryption key which can be used to decrypt the context. In this embodiment, the entity 901 finds the criteria and does not assume any special activity from the cloud besides that both the criteria and the encrypted context are available for querying.

In another embodiment, it is the cloud 111a that is active, meaning that the entity 901 offers to the cloud a representation of its own local information as potential criteria. This information can be all of the public information of entity 901 or a subset of the information from entity 901 selected by the entity 901 based on some criteria. In this case the entity 901 may offer several criteria in a sequence to the cloud 111a.

Subsequently, the cloud 111a performs internal comparison of the offered criteria. If an offered criteria matches, the cloud indicates that decryption is feasible. If the matching of the offered criteria is a complete match, the entity 901 may initiate the process for obtaining the decryption key from the execution security platform 103. If the cloud 111a concludes that one or more of its stored criteria are found within the offered criteria (may happen if the offered criteria is the complete information of an entity 901) the cloud 111a may indicate all of the criteria to the entity 901. Alternatively, the cloud 111a may indicate only that some criteria are feasible, but not all of them. This can lead to a separate negotiation process between the entity 901 and cloud 111a to find out which parts of the offered criteria are eligible to be used.

In one embodiment, the cloud 111a may be required not to make the criteria public, but implement an internal table which keeps track of the relation between the criteria and the associated encrypted context. This can be thought of as decomposition of the full graph of the entity 901. Either entity 901 decomposes the full graph and offers the decomposed pieces to the cloud 111a or the cloud 111a checks the full graph of entity 901 internally against all of the criteria in the cloud 111a.

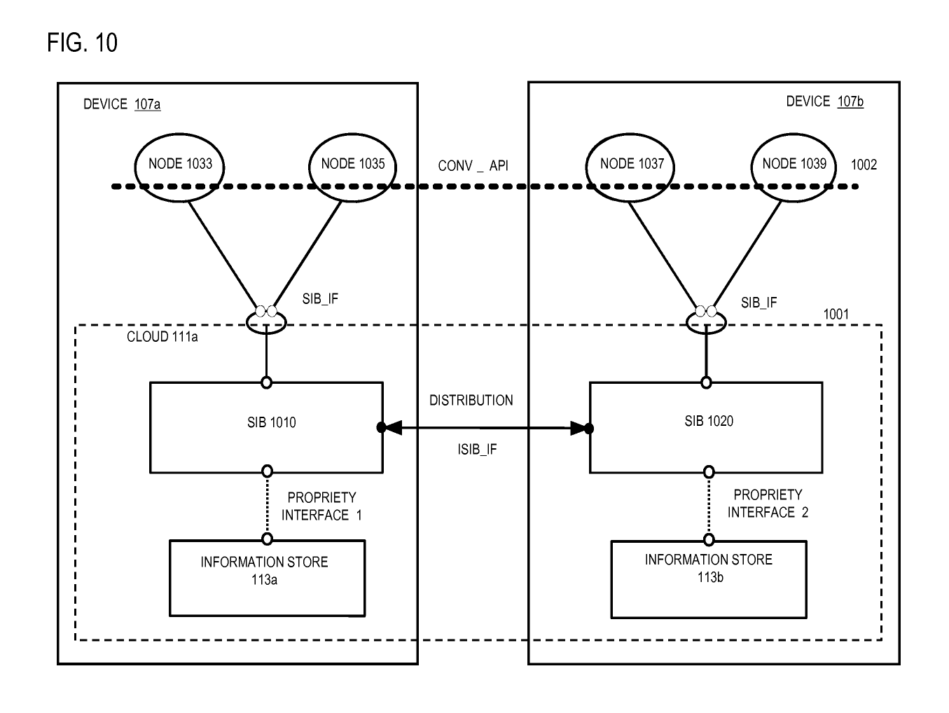

FIG. 10 is a diagram of a cloud structure for applying execution context criteria for secure execution context sharing, according to one embodiment. Each cloud 111a includes cloud nodes/objects 1033, 1035, 1037, and 1039 and semantic information brokers (SIB) 1010, 1020 which form the nucleus of the cloud 111a. Each SIB is an entity performing triple governance in possible co-operation with other SIBs for one cloud 111a. A SIB may be a concrete or virtual entity. Each SIB also supports the cloud nodes/objects 1033, 1035, 1037, and 1039 (e.g., a user, a mobile terminal, or a PC) interacting with other SIBs through information transaction operations required by the system 100 of FIG. 1, such as accessing various information records for data mining thereby out-reaching the targeted recipients. Any participants of the system 100 can also post their execution and/or context at any node 1033, 1035, 1037, and 1039 to make the information and the computations (e.g., computation closures) available for the system 100 to match with different sets of context criteria.

From the perspective of the recipients, they do not have to sign-up with any commercial, professional, or social network website in order to receive the above-described messages. Any information the recipients ever provide to a public and/or private entity in the real world or in the virtual world can be incorporated into the cloud 111a as granted by the recipients/participants. The entity can be a real world legal entity or a virtual entity (e.g., an avatar). For example, the information records include the government records (e.g., birth certificates, school records, driver's licenses, tax records, real property records, criminal records, etc.), commercial activity records (e.g., flight tickets, movie tickets, CD/DVD/book purchases, restaurant/store/hospital/gym visits, car/house/education loans, credit debts, phone/utility/heating bills, internet browsing behaviors, etc.), personal activity records (e.g., basketball teams, hikes, etc.). The system 100 data-mines the information records to uncover patterns of the recipients in data either with or without their real-world identification. When the system 100 is allowed by the recipients only to data-mine without associating the information or computations with their real-world identification, the system 100 can associate the data mining results with a reference that may be tied to an alias of the recipient such that the system 100 can send messages to the recipient later. The above-described embodiments reach the recipients over a secure, encrypted mechanism to ensure total confidentiality. The system 100 protect the privacy and confidentiality of the recipients by eliminating the sender's need to know the recipient identification (e.g., names, email addresses, etc.). The system 100 uses the information regarding the messages and the corresponding recipients with authorization of the senders and the recipients.

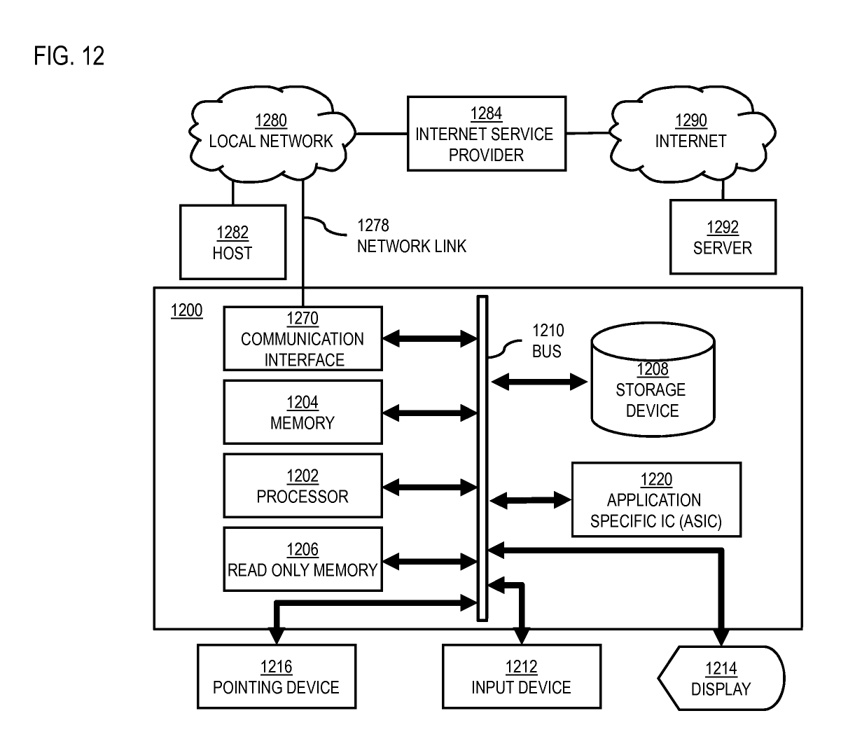

The devices 107a, 107b may be any devices (e.g., a mobile terminal, a personal computer, etc.) or equipment (e.g., a server, a router, etc.). By way of example, RDF can be used in the cloud 111a. The triple governance transactions in the cloud 111a uses a cloud Access Protocol (SSAP) to, e.g., join, leave, insert, remove, update, query, subscribe, unsubscribe information (e.g., in a unit of a triple). A subscription is a special query that is used to trigger reactions to persistent queries for information and computations. Persistent queries are particular cases of plain queries. The physical distribution protocol of a cloud (e.g., SSAP) allows formation of a cloud using multiple SIBs 1010 and 1020. With transactional operations, a node/object produces/inserts and consumes/queries information in the cloud 111a. As distributed SIBs belong to the same cloud 111a, query and subscription operations cover the whole information and computation extent of a cloud. According to an embodiment the SSAP endpoint can be implemented as part of the computer system 1200 of FIG. 12, for example, on top of communication interface 1270 of FIG. 12 and/or as an extension of the internal bus 1210 of FIG. 12.

FIG. 10 also shows an implementation structure of the system 100 in the cloud 111a, the cloud 111a is depicted in the box in a broken line 1001 (as the boundary of the cloud). There are two devices 107a and 107b connected to the cloud. In the upper part of FIG. 10, a dotted line 1002 illustrates the boundaries of the devices. The devices can be mobile terminals, personal computers, servers, or the like. Each device can include nodes (e.g., two) therein. Each node represents a knowledge processor (KP). KPs are entities contributing to inserting and removing contexts as well as querying and subscribing content according to ontology relevant to its defined functionality. A KP needs one or more partner KPs for sharing context and for implementing an agreed semantics for the used ontology. With this implementation structure, the cloud 111a serves private and public entities in different domains A and B using the devices 107a and 107b and KPs running in the domains A, in order to support the private and public entities to access information services and the system 100. According to certain embodiments, the KPs may require memory (such as memory 1204 of FIG. 12) and/or processor (such as processor 1202 of FIG. 12) resources in addition to using communication mechanism (such as 1270 of FIG. 12). Also, the may use a storage device (such as 1208 of FIG. 12) and/or read only memory (such as 1206 of FIG. 12).

In this embodiment, the internal and external AugBDD tables are embedded in the SSAP protocol at SIB_IF or ISIB_IF upon an “insert” protocol message. The system 100 builds itself on top of the cloud protocol, to use ontological constructs for processing RDF graphs, ROBDDs, hash identifiers for the recipient criteria and the secret data. The SIB_IF is an interface between the SIBs and a device, and the ISIB_IF is an interface between two SIBs.

In one embodiment, the approach described herein is implemented at the interfaces SIB_IF and ISIB_IF of the system 100 to transmit the hash IDs and the encrypted execution context packets. In other embodiments, one or more application programming interfaces (APIs) (e.g., third party APIs) can be used in addition to or instead of SIB_IF and ISIB_IF. The approach described herein provides performance gains while allowing multiple proprietary implementations of information stores 113a-113m and computation stores 115a-115m in the cloud 111a according to FIG. 10. The decoding complexity for developing an application is buried below a convenience API (CONV API) according to FIG. 10. Similarly, the tools for a local (at the node level) information search are provided as a part of a convenience library.

As discussed, the augmentation of construction history and other information related to the ROBDD of the context criteria and the execution context can be embedded in the corresponding AugBDDs. In one embodiment, the cloud protocol messages are checked for hash ID consistency by (1) checking for the correct (according to ontology) types of hash IDs in term of a range and a domain of the instances that have a defined property between them, and (2) checking for a correct number of hash IDs connected by the defined properties. In other words, the (1) and (2) mechanisms are applied to detect the cloud_robdd_id concept within the cloud messages and then perform the checking for the availability of hash IDs from the external index table. The request for a missing hash ID can then be executed via a cloud query. This query relies upon the ROBDD graphs being available in a SIB in the cloud. The AugBDDs can be sent over to a remote system that uses the AugBDDs locally to check the consistency of the hash IDs or other properties in local information stores, which allows checking for ontology conformance without direct access to the ontology description.

One of the problems of sharing information and computations in the cloud environment (e.g., semantic web) is to share the graphs or parts of the graphs (e.g., subgraphs) among distributed nodes and entities via information stores and computation stores with sufficient identification of the graphs (especially the subgraphs) while minimizing communication traffic. Private cloud allows each entity to set the shared portions of the cloud with different entities.

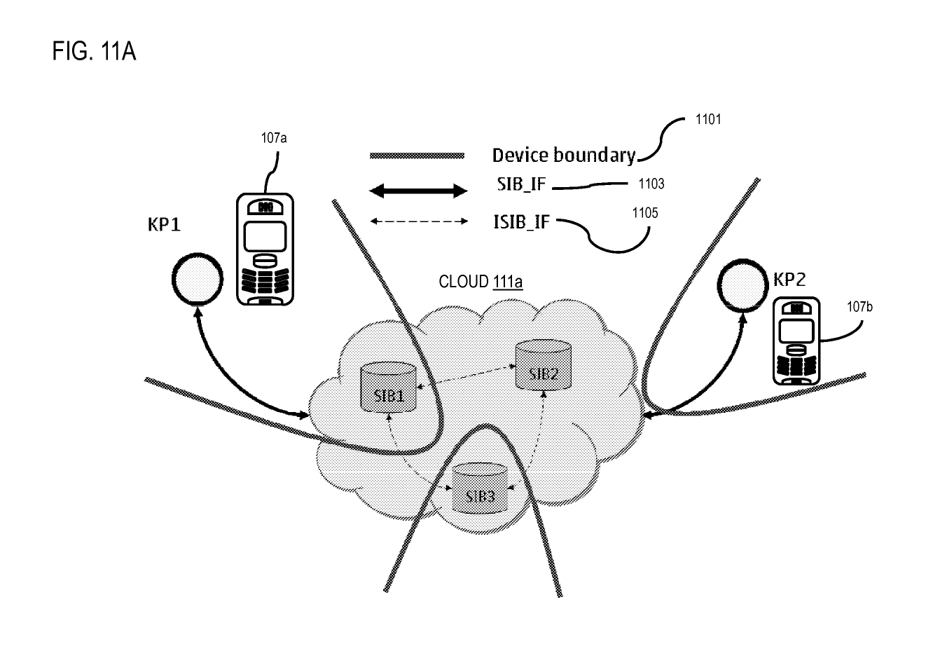

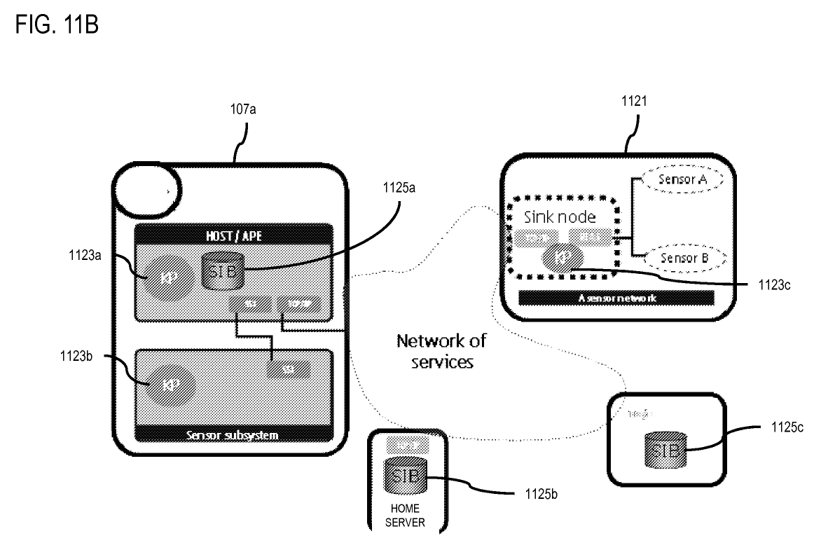

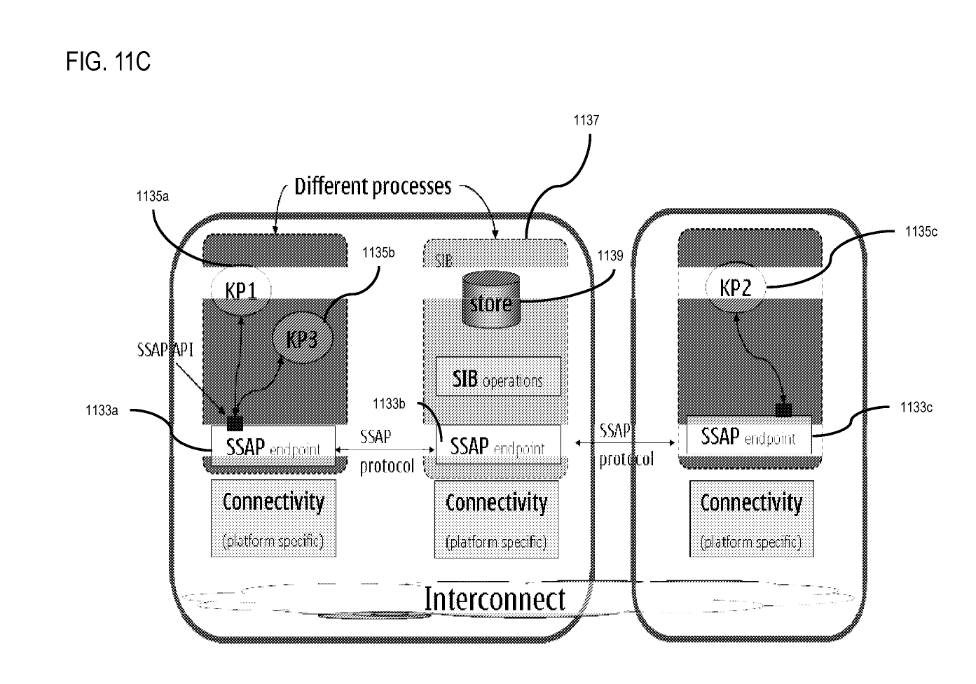

FIGS. 11A-11C are diagrams of a cloud environment, according to one embodiment. On conceptual level the cloud 111a has nodes, known as Knowledge Processors (KPs) and the information stores and computation storesd, which may consist of several Semantic Information Brokers (SIBs). The different actors may exist in different physical devices as exemplified by FIG. 11A. As shown in FIG. 11A, the cloud environment may consist of several domains, such as mobile devices 107a and 107b. FIG. 11A also shows the boundaries 1101, 1103, and 1105 within the cloud environment.

FIG. 11B shows other domains such as a sensor network 1121. A more detailed view on the possible configuration of used software inside a device is shown in FIG. 11B. A device 107a in this case may be a mobile device, a PC which is expected to have the usual associated resources (e.g., memory, CPU, network interface(s) and potentially storage available). A device 107a which only contains one or more Knowledge Processors (KP) 1123a, 1123b, and 1123c may be simpler than the one containing one or more SIB 1125a, 1125b, and 1125c. In one embodiment, a Public Key Generation functionality may be part of the cloud or be offered as a separate service.

The architecture of FIG. 11C shows a mapping of the cloud concepts of FIG. 11B. The SSAP endpoints 1133a, 1133b, and 1133c can be implemented on top of the communication interface (1270 in FIG. 12), but it is noted that this may act as an extension of the internal bus (1210 in FIG. 12). Knowledge Processors (KPs) 1135a, 1135b, 1135c require memory (1204 in FIG. 12) and processor (1202 in FIG. 12) resources in addition to using the communication mechanism (1270 in FIG. 12). They may use storage device (1208 in FIG. 12) and Read Only Memory (1206 in FIG. 12). From cloud point of view the KPs 1135a-1135c do not use anything else, but they may be linked to other programs which access input and output devices. The SIB 1137 contains all the features of a KP, but it always has a storage 1139, wherein the storage 1139 may be mapped onto a memory (not shown).

It is noted that the described entities KPs, SIBS, SSAPs, etc. can be software, hardware (e.g., 1220 in FIG. 12) or a combination thereof. For instance a KP 1135a that contains a single sensor and connectivity that allows it to publish its values to cloud 111a can be implemented as software, hardware, or a combination thereof. In principle even a SIB 1137 may be implemented as hardware and the calculations needed to construct the AugBDDs may be amenable to hardware implementation.

The processes described herein for providing secure access to execution context may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 12 illustrates a computer system 1200 upon which an embodiment of the invention may be implemented. Although computer system 1200 is depicted with respect to a particular device or equipment, it is contemplated that other devices or equipment (e.g., network elements, servers, etc.) within FIG. 12 can deploy the illustrated hardware and components of system 1200. Computer system 1200 is programmed (e.g., via computer program code or instructions) to provide secure access to execution context as described herein and includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1200, or a portion thereof, constitutes a means for performing one or more steps of providing secure access to execution context.

A bus 1210 includes one or more parallel conductors of information so that information is transferred quickly among devices coupled to the bus 1210. One or more processors 1202 for processing information are coupled with the bus 1210.

A processor (or multiple processors) 1202 performs a set of operations on information as specified by computer program code related to providing secure access to execution context. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1200 also includes a memory 1204 coupled to bus 1210. The memory 1204, such as a random access memory (RAM) or any other dynamic storage device, stores information including processor instructions for providing secure access to execution context. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or any other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk or flash card, for storing information, including instructions, that persists even when the computer system 1200 is turned off or otherwise loses power.

Information, including instructions for providing secure access to execution context, is provided to the bus 1210 for use by the processor from an external input device 1212, such as a keyboard containing alphanumeric keys operated by a human user, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a cathode ray tube (CRT), a liquid crystal display (LCD), a light emitting diode (LED) display, an organic LED (OLED) display, a plasma screen, or a printer for presenting text or images, and a pointing device 1216, such as a mouse, a trackball, cursor direction keys, or a motion sensor, for controlling a position of a small cursor image presented on the display 1214 and issuing commands associated with graphical elements presented on the display 1214. In some embodiments, for example, in embodiments in which the computer system 1200 performs all functions automatically without human input, one or more of external input device 1212, display device 1214 and pointing device 1216 is omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of ASICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver. In certain embodiments, the communications interface 1270 enables connection to the communication network 105 for providing secure access to execution context to the UEs 107a-107i.

The term “computer-readable medium” as used herein refers to any medium that participates in providing information to processor 1202, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1208. Volatile media include, for example, dynamic memory 1204. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1220.

Network link 1278 typically provides information communication using transmission media through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290.

A computer called a server host 1292 connected to the Internet hosts a process that provides a service in response to information received over the Internet. For example, server host 1292 hosts a process that provides information representing video data for presentation at display 1214. It is contemplated that the components of system 1200 can be deployed in various configurations within other computer systems, e.g., host 1282 and server 1292.

At least some embodiments of the invention are related to the use of computer system 1200 for implementing some or all of the techniques described herein. According to one embodiment of the invention, those techniques are performed by computer system 1200 in response to processor 1202 executing one or more sequences of one or more processor instructions contained in memory 1204. Such instructions, also called computer instructions, software and program code, may be read into memory 1204 from another computer-readable medium such as storage device 1208 or network link 1278. Execution of the sequences of instructions contained in memory 1204 causes processor 1202 to perform one or more of the method steps described herein. In alternative embodiments, hardware, such as ASIC 1220, may be used in place of or in combination with software to implement the invention. Thus, embodiments of the invention are not limited to any specific combination of hardware and software, unless otherwise explicitly stated herein.

The signals transmitted over network link 1278 and other networks through communications interface 1270, carry information to and from computer system 1200. Computer system 1200 can send and receive information, including program code, through the networks 1280, 1290 among others, through network link 1278 and communications interface 1270. In an example using the Internet 1290, a server host 1292 transmits program code for a particular application, requested by a message sent from computer 1200, through Internet 1290, ISP equipment 1284, local network 1280 and communications interface 1270. The received code may be executed by processor 1202 as it is received, or may be stored in memory 1204 or in storage device 1208 or any other non-volatile storage for later execution, or both. In this manner, computer system 1200 may obtain application program code in the form of signals on a carrier wave.

Various forms of computer readable media may be involved in carrying one or more sequence of instructions or data or both to processor 1202 for execution. For example, instructions and data may initially be carried on a magnetic disk of a remote computer such as host 1282. The remote computer loads the instructions and data into its dynamic memory and sends the instructions and data over a telephone line using a modem. A modem local to the computer system 1200 receives the instructions and data on a telephone line and uses an infra-red transmitter to convert the instructions and data to a signal on an infra-red carrier wave serving as the network link 1278. An infrared detector serving as communications interface 1270 receives the instructions and data carried in the infrared signal and places information representing the instructions and data onto bus 1210. Bus 1210 carries the information to memory 1204 from which processor 1202 retrieves and executes the instructions using some of the data sent with the instructions. The instructions and data received in memory 1204 may optionally be stored on storage device 1208, either before or after execution by the processor 1202.

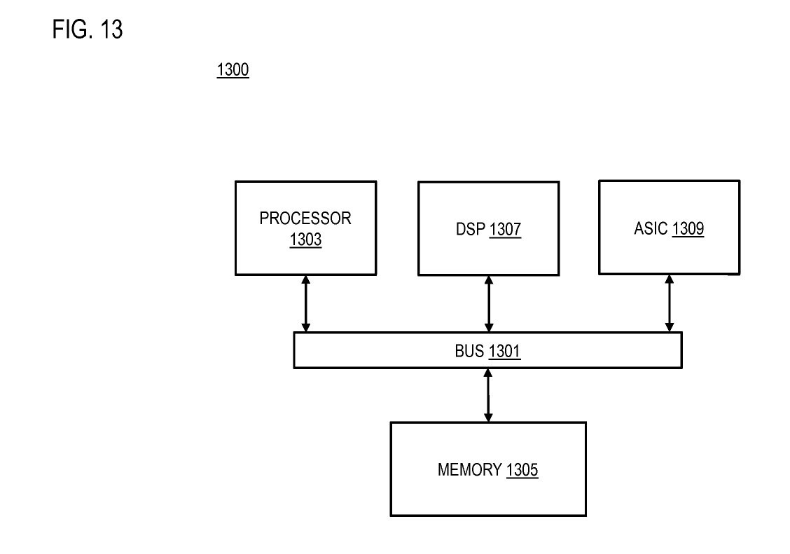

FIG. 13 illustrates a chip set or chip 1300 upon which an embodiment of the invention may be implemented. Chip set 1300 is programmed to provide secure access to execution context as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1300 can be implemented in a single chip. It is further contemplated that in certain embodiments the chip set or chip 1300 can be implemented as a single “system on a chip.” It is further contemplated that in certain embodiments a separate ASIC would not be used, for example, and that all relevant functions as disclosed herein would be performed by a processor or processors. Chip set or chip 1300, or a portion thereof, constitutes a means for performing one or more steps of providing user interface navigation information associated with the availability of functions. Chip set or chip 1300, or a portion thereof, constitutes a means for performing one or more steps of providing secure access to execution context.

In one embodiment, the chip set or chip 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1300 includes merely one or more processors and some software and/or firmware supporting and/or relating to and/or for the one or more processors.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to provide secure access to execution context. The memory 1305 also stores the data associated with or generated by the execution of the inventive steps.

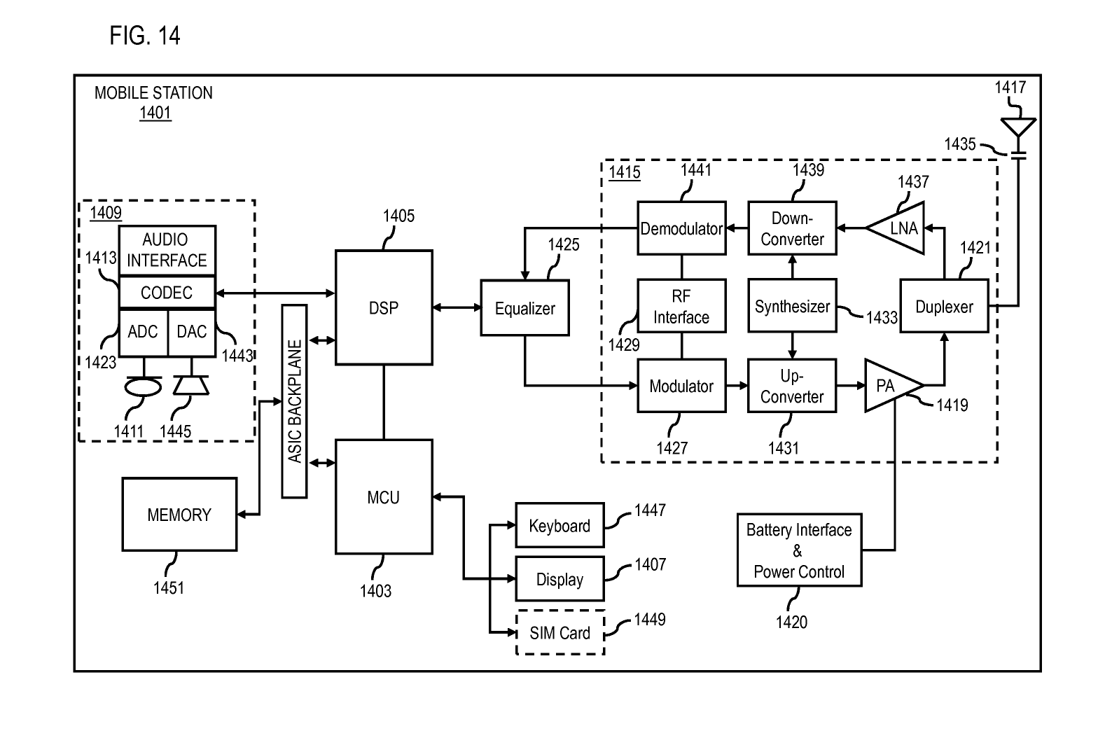

FIG. 14 is a diagram of exemplary components of a mobile terminal (e.g., handset) for communications, which is capable of operating in the system of FIG. 1, according to one embodiment. In some embodiments, mobile terminal 1401, or a portion thereof, constitutes a means for performing one or more steps of providing secure access to execution context. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1403, a Digital Signal Processor (DSP) 1405, and a receiver/transmitter unit including a microphone gain control unit and a speaker gain control unit. A main display unit 1407 provides a display to the user in support of various applications and mobile terminal functions that perform or support the steps of providing secure access to execution context. The display 1407 includes display circuitry configured to display at least a portion of a user interface of the mobile terminal (e.g., mobile telephone). Additionally, the display 1407 and display circuitry are configured to facilitate user control of at least some functions of the mobile terminal. An audio function circuitry 1409 includes a microphone 1411 and microphone amplifier that amplifies the speech signal output from the microphone 1411. The amplified speech signal output from the microphone 1411 is fed to a coder/decoder (CODEC) 1413.

A radio section 1415 amplifies power and converts frequency in order to communicate with a base station, which is included in a mobile communication system, via antenna 1417. The power amplifier (PA) 1419 and the transmitter/modulation circuitry are operationally responsive to the MCU 1403, with an output from the PA 1419 coupled to the duplexer 1421 or circulator or antenna switch, as known in the art. The PA 1419 also couples to a battery interface and power control unit 1420.

In use, a user of mobile terminal 1401 speaks into the microphone 1411 and his or her voice along with any detected background noise is converted into an analog voltage. The analog voltage is then converted into a digital signal through the Analog to Digital Converter (ADC) 1423. The control unit 1403 routes the digital signal into the DSP 1405 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1425 for compensation of any frequency-dependent impairments that occur during transmission though the air such as phase and amplitude distortion. After equalizing the bit stream, the modulator 1427 combines the signal with a RF signal generated in the RF interface 1429. The modulator 1427 generates a sine wave by way of frequency or phase modulation. In order to prepare the signal for transmission, an up-converter 1431 combines the sine wave output from the modulator 1427 with another sine wave generated by a synthesizer 1433 to achieve the desired frequency of transmission. The signal is then sent through a PA 1419 to increase the signal to an appropriate power level. In practical systems, the PA 1419 acts as a variable gain amplifier whose gain is controlled by the DSP 1405 from information received from a network base station. The signal is then filtered within the duplexer 1421 and optionally sent to an antenna coupler 1435 to match impedances to provide maximum power transfer. Finally, the signal is transmitted via antenna 1417 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1401 are received via antenna 1417 and immediately amplified by a low noise amplifier (LNA) 1437. A down-converter 1439 lowers the carrier frequency while the demodulator 1441 strips away the RF leaving only a digital bit stream. The signal then goes through the equalizer 1425 and is processed by the DSP 1405. A Digital to Analog Converter (DAC) 1443 converts the signal and the resulting output is transmitted to the user through the speaker 1445, all under control of a Main Control Unit (MCU) 1403 which can be implemented as a Central Processing Unit (CPU) (not shown).

The MCU 1403 receives various signals including input signals from the keyboard 1447. The keyboard 1447 and/or the MCU 1403 in combination with other user input components (e.g., the microphone 1411) comprise a user interface circuitry for managing user input. The MCU 1403 runs a user interface software to facilitate user control of at least some functions of the mobile terminal 1401 to provide secure access to execution context. The MCU 1403 also delivers a display command and a switch command to the display 1407 and to the speech output switching controller, respectively. Further, the MCU 1403 exchanges information with the DSP 1405 and can access an optionally incorporated SIM card 1449 and a memory 1451. In addition, the MCU 1403 executes various control functions required of the terminal. The DSP 1405 may, depending upon the implementation, perform any of a variety of conventional digital processing functions on the voice signals. Additionally, DSP 1405 determines the background noise level of the local environment from the signals detected by microphone 1411 and sets the gain of microphone 1411 to a level selected to compensate for the natural tendency of the user of the mobile terminal 1401.

The CODEC 1413 includes the ADC 1423 and DAC 1443. The memory 1451 stores various data including call incoming tone data and is capable of storing other data including music data received via, e.g., the global Internet. The software module could reside in RAM memory, flash memory, registers, or any other form of writable storage medium known in the art. The memory device 1451 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1449 carries, for instance, important information, such as the cellular phone number, the carrier supplying service, subscription details, and security information. The SIM card 1449 serves primarily to identify the mobile terminal 1401 on a radio network. The card 1449 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
an execution context of a device, the execution context including at least in part one or more computation closures;
a processing of the execution context, the one or more computation closures, or a combination thereof to cause, at least in part, decomposition of the execution context, the one or more computation closures, or a combination thereof into, at least in part, one or more context criteria and content information; and
at least one determination to encrypt the execution context, the one or more computation closures, the content information, or a combination thereof using the one or more context criteria as a public key of an identity-based encryption.

2. A method of claim 1, wherein the (1) data and/or (2) information and/or (3) at least one signal are further based, at least in part, on the following:
a processing of the content information to determine private information; and
an exclusion of the private information from the one or more context criteria.

3. A method of claim 1, wherein the (1) data and/or (2) information and/or (3) at least one signal are further based, at least in part, on the following:
one or more other keys for accessing at least a portion of the content information; and
at least one determination to augment the one or more context criteria with at least one of the one or more other keys.

4. A method of claim 3, wherein the one or more other keys include, at least in part, one or more digital rights management keys.

5. A method of claim 3, wherein the (1) data and/or (2) information and/or (3) at least one signal are further based, at least in part, on the following:
an input for specifying the one or more other keys, other private information, or a combination thereof associated with the content information,
wherein the augmenting of the one or more context criteria comprises, at least in part, associating the one or more other keys, the other private information, or a combination thereof with the one or more context criteria.

6. A method of claim 5, wherein the other private information include, at least in part, one or more personal identifiers.

7. A method of claim 1, wherein the (1) data and/or (2) information and/or (3) at least one signal are further based, at least in part, on the following:
a processing of the execution context to add supplemental information,
wherein access to the execution context is contingent, at least in part, on accessing the supplemental information.

8. A method of claim 7, wherein the supplemental information includes, at least in part, advertisement information, coupon information, gift voucher information, or a combination thereof.

9. A method of claim 1, wherein the (1) data and/or (2) information and/or (3) at least one signal are further based, at least in part, on the following:
a publication of the encrypted execution context, the encrypted one or more computation closures, the encrypted content information, or a combination thereof to an information store, a network service, a network storage, or a combination thereof,
wherein the encrypted execution context, the encrypted one or more computation closures, the encrypted content information, or a combination thereof is retrieved or decrypted from the information store, the network service, the network storage, or the combination thereof based, at least in part, on satisfying the one or more context criteria.

10. A method of claim 1, wherein the one or more computation closures are known computation closures from a library, part of at least one functional flow, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine an execution context of a device, the execution context including at least in part one or more computation closures;
process and/or facilitating a process of the execution context, the one or more computation closures, or a combination thereof to cause, at least in part, decomposition of the execution context, the one or more computation closures, or a combination thereof into, at least in part, one or more context criteria and content information; and
determine to encrypt the execution context, the one or more computation closures, the content information, or a combination thereof using the one or more context criteria as a public key of an identity-based encryption.

12. An apparatus of claim 11, wherein the apparatus is further caused to:
process and/or facilitate a processing of the content information to determine private information; and
cause, at least in part, an exclusion of the private information from the one or more context criteria.

13. An apparatus of claim 11, wherein the apparatus is further caused to:
determine one or more other keys for accessing at least a portion of the content information; and
determine to augment the one or more context criteria with at least one of the one or more other keys.

14. An apparatus of claim 13, wherein the one or more other keys include, at least in part, one or more digital rights management keys.

15. An apparatus of claim 13, wherein the apparatus is further caused to:
receive an input for specifying the one or more other keys, other private information, or a combination thereof associated with the content information,
wherein the augmenting of the one or more context criteria comprises, at least in part, associating the one or more other keys, the other private information, or a combination thereof with the one or more context criteria.

16. An apparatus of claim 15, wherein the other private information include, at least in part, one or more personal identifiers.

17. An apparatus of claim 11, wherein the apparatus is further caused to:
process and/or facilitate a processing of the execution context to add supplemental information,
wherein access to the execution context is contingent, at least in part, on accessing the supplement information.

18. An apparatus of claim 17, wherein the supplemental information includes, at least in part, advertisement information, coupon information, gift voucher information, or a combination thereof.

19. An apparatus of claim 11, wherein the apparatus is further caused to:
cause, at least in part, publication of the encrypted execution context, the encrypted one or more computation closures, the encrypted content information, or a combination thereof to an information store, a network service, a network storage, or a combination thereof,
wherein the encrypted execution context, the encrypted one or more computation closures, the encrypted content information, or a combination thereof is retrieved or decrypted from the information store, the network service, the network storage, or the combination thereof based, at least in part, on satisfying the one or more context criteria.

20. An apparatus of claim 11, wherein the one or more computation closures are known computation closures from a library, part of at least one functional flow, or a combination thereof.
